(19) United States
(12) Patent Application Publication
(10) Pub. No.: US 2003/0141246 A1
(43) Pub. Date: Jul. 31, 2003

(54) Regenerating apparatus and method for resist stripping waste liquids

(76) Inventors: Shu Ogawa, Tokyo (JP); Yasuyuki Kobayakawa, Tokyo (JP); Yoshiya Kitagawa, Yokohama-shi (JP); Makoto Kikukawa, Yokohama-shi (JP); Takayuki Kaneyasu, Yokohama-shi (JP)

Correspondence Address: ROSENTHAL & OSHA L.L.P., Suite 2800, 1221 McKinney Street, Houston, TX, 77010, US

(21) Appl. No.: 10/307,269

(22) Filed: Nov. 27, 2002

(30) Foreign Application Priority Data
Nov. 29, 2001 (JP) P2001-365033

(51) Int. Cl. B01D 11/00

(52) U.S. Cl. 210/634; 210/96.2; 210/199; 210/195.2; 210/662; 210/674

(57) ABSTRACT

The resist stripping waste liquid regenerating apparatus of the invention regenerates a resist stripping waste liquid to obtain a resist stripping regenerated liquid. The apparatus is provided with a membrane separating apparatus which employs a membrane with a molecular weight cutoff of 100-1500 to separate a resist stripping waste liquid into a concentrated liquid and a permeating liquid, an adjusting tank which stores the permeating liquid and adjusts the concentration of an alkanolamine and organic solvent, means for supplying the alkanolamine to the adjusting tank, and means for supplying the organic solvent to the adjusting tank. This construction adequately reduces the resist concentration of the permeating liquid since the resist in the resist stripping waste liquid cannot permeate the membrane. It is thereby possible to lessen the need for dilution of the resist concentration and thus satisfactorily reduce the amount of alkanolamine and organic solvent supplied to the adjusting tank.

### BACKGROUND OF THE INVENTION

1. Field of the Invention

The present invention relates to a regenerating apparatus and method for resist stripping waste liquids.

2. Related Background Art

Manufacture of electronic parts such as semiconductors, liquid crystals, printed boards and the like usually includes a film-forming step in which a negative or positive photoresist film is formed on a substrate such as an Si wafer, an irradiation step in which light or the like is irradiated through a pattern mask, a dissolution step in which a developer liquid is used to dissolve unwanted photoresist, an etching step in which etching treatment or the like is carried out, and a stripping step in which the resist film on the substrate is stripped, wherein the stripping step employs a resist stripping liquid for stripping of the resist film.

The resist stripping liquid usually consists of an organic solvent, an alkanolamine and water, and using that type of resist stripping liquid dissolves the resist film on the substrate into the resist stripping liquid to strip it from the substrate, producing a resist stripping liquid containing the dissolved resist.

Methods of regenerating such resist stripping liquids have included the method disclosed in Japanese Patent Publication No. 2602179. This regenerating method involves storing the resist stripping waste liquid in a concentration-adjusting tank, removing the resist stripping waste liquid from the concentration-adjusting tank, measuring the concentration of the organic solvent, alkanolamine and dissolved resist in the resist stripping waste liquid with a spectrophotometer and supplying the organic solvent and alkanolamine to the concentration-adjusting tank based on the measurements to adjust the concentrations of the organic solvent, alkanolamine and dissolved resist, for regeneration of the resist stripping waste liquid.

### SUMMARY OF THE INVENTION

However, the regenerating method described in this prior art publication is associated with the following problems.

Specifically, the dissolved resist is not removed from the resist stripping waste liquid in the aforementioned prior art regenerating method. For regeneration of the resist stripping waste liquid, therefore, it is necessary to adequately dilute the dissolved resist concentration to adjust the resist concentration. Large amounts of the organic solvent and alkanolamine must therefore be supplied to the concentration-adjusting tank, resulting in increased waste liquid being discharged from the concentration-adjusting tank.

The waste liquid is usually incinerated, emitting CO₂ into the atmosphere, and since a large amount of waste liquid is discharged from the concentration-adjusting tank as explained above, this increases the amount of CO₂ released into the atmosphere and creates a undesirable situation from the viewpoint of preventing global warming.

Also, since large volumes of the organic solvent and alkanolamine are supplied to the concentration-adjusting tank in the above-mentioned prior art regenerating method, the running cost is considerably higher.

In light of these circumstances, it is an object of the present invention to provide a regenerating apparatus and method for resist stripping waste liquids which can adequately reduce the volumes of alkanolamine and organic solvent supplied during regeneration of resist stripping waste liquids.

In order to solve the problems described above, the regenerating apparatus for resist stripping waste liquids according to the invention is one which regenerates a resist stripping waste liquid to produce a resist stripping regenerated liquid, and it is provided with a membrane separating apparatus having a membrane with a molecular weight cutoff (fractionating molecular weight) of 100-1500 for separation of the resist stripping waste liquid into a concentrated liquid and a permeating liquid, a concentration-adjusting tank which stores the permeating liquid and adjusts the concentration of the alkanolamine and organic solvent in the permeating liquid, alkanolamine supply means which supplies the alkanolamine to the concentration-adjusting tank, and organic solvent supply means which supplies the organic solvent to the concentration-adjusting tank.

In the regenerating apparatus for resist stripping waste liquids having this construction, the resist stripping waste liquid is separated into a concentrated liquid and a permeating liquid by the membrane in the membrane separating apparatus, and the permeating liquid is stored in the concentration-adjusting tank. Also, the alkanolamine is supplied by alkanolamine supply means and the organic solvent is supplied by organic solvent supply means to the concentration-adjusting tank. Adjustment of the alkanolamine and organic solvent concentrations in the concentration-adjusting tank is accomplished in this manner.

Since the membrane used in the membrane separating apparatus has a molecular weight cutoff of 100-1500, the resist contained in the resist stripping waste liquid can hardly permeate through the membrane, to thereby allow adequate reduction of the resist concentration in the permeating liquid. This minimizes the need for diluting the resist concentration in the concentration-adjusting tank, and results in substantial reduction in the amount of alkanolamine and organic solvent which must be supplied to the concentration-adjusting tank.

Also, since the resist concentration of the permeating liquid is adequately reduced, it is possible to regenerate the resist stripping waste liquid to almost the same state as the original resist stripping liquid.

More specifically, the membrane is preferably a nanofiltration membrane, for instance.

The regenerating apparatus is also preferably provided with recirculating means to recirculate the concentrated liquid separated by the membrane to the upstream end of the membrane separating apparatus.

In this case, recirculation of the concentrated liquid separated by the membrane of the membrane separating apparatus to the upstream end of the membrane separating apparatus by the recirculating means allows filtration during circulation of the resist stripping waste liquid. The alkanolamine and organic solvent can thus be effectively utilized without being discarded. This can significantly reduce the amount of alkanolamine and organic solvent which must be supplied to the concentration-adjusting apparatus, as compared to systems in which the concentrated liquid separated by the membrane separating apparatus is discarded after use.

The regenerating method for resist stripping waste liquids according to the invention is a method for regenerating resist stripping waste liquids containing an alkanolamine, an organic solvent and a resist in a manner which effectively utilizes the regenerating apparatus for resist stripping waste liquids according to the invention, and the method comprises a membrane separating step in which a membrane with a molecular weight cutoff of 100-1500 is used to separate a resist stripping waste liquid into a concentrated liquid and a permeating liquid, and a concentration-adjusting step in which the alkanolamine and/or the organic solvent are supplied to the permeating liquid to adjust the concentration of the permeating liquid.

According to this method, the resist stripping waste liquid is separated into a concentrated liquid and a permeating liquid using a membrane with a molecular weight cutoff of 100-1500. This results in adequate reduction of the resist concentration in the permeating liquid since the resist cannot permeate the membrane. The need for dilution of the resist concentration is therefore lessened as compared to the method disclosed in Japanese Patent Publication No. 2602179 which involves only supply of the alkanolamine and/or the organic solvent to adjust the concentration of the resist stripping waste liquid. It is therefore possible to correspondingly reduce the amount of alkanolamine and/or organic solvent that must be supplied to the permeating liquid.

Also, since the resist concentration of the permeating liquid can be adequately reduced, the resist stripping waste liquid can be regenerated to almost the same state as the original resist stripping liquid.

The term “molecular weight” used for the purpose of the present invention refers to the value which indicates the rejection performance of the membrane. Specifically, the molecular weight is determined based on the rejection performance on known proteins and other high molecular substances, and it is represented as the minimum molecular weight that can be blocked by the membrane under the certain standard conditions.

### BRIEF DESCRIPTION OF THE DRAWINGS

FIG. 1 is a flow diagram showing an embodiment of a regenerating apparatus for resist stripping waste liquids according to the invention.

FIG. 2 is a partial cross-sectional view of an example of a membrane separating apparatus.

### PREFERRED EMBODIMENT OF THE INVENTION

A preferred embodiment of the invention will now be explained in detail.

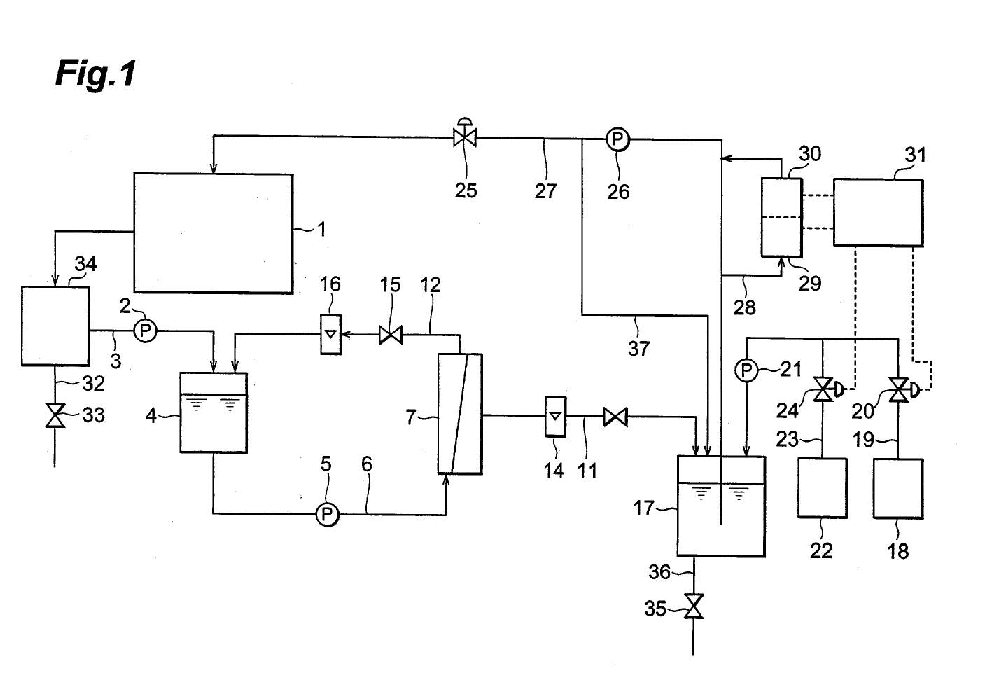

In FIG. 1, numeral 1 represents a resist stripping apparatus which employs a resist stripping liquid to strip a resist film from a substrate such as an Si wafer. The resist stripping liquid is composed of an alkanolamine, organic solvent, water, etc. Dissolution of the resist into the resist stripping liquid at the resist stripping apparatus 1 produces a resist stripping waste liquid containing the alkanolamine, organic solvent, water and resist.

The resist stripping waste liquid obtained in this manner is received into a storage tank 34 and then transported by a pump 2 through a conduit 3 to a concentrating tank 4. The resist stripping waste liquid stored in the concentrating tank 4 is transported by a flow-regulating pump 5 through a conduit 6 to a membrane separating apparatus 7.

The membrane separating apparatus 7 employs a membrane to separate the resist stripping waste liquid into a concentrated liquid and a permeating liquid. The membrane used may be one with a molecular weight cutoff of 100-1500. The molecular weight cutoff is preferably 400-1200 and more preferably 700-1000.

If the molecular weight cutoff is less than 100, the resist dissolved in the resist stripping waste liquid can be removed but the alkanolamine and organic solvent may also be captured by the membrane. On the other hand, if the molecular weight cutoff is greater than 1500, the resist dissolved in the resist stripping waste liquid can no longer be removed.

The membrane having such a molecular weight cutoff may be a nanofiltration (hereinafter abbreviated to “NF”) membrane, for example. As examples of NF membranes there may be mentioned NTR-7410, NTR-7450, NTR-725HF, NTR-7250, NTR-729HF and NTR-769SR by Nitto Denko Corp., SU-200S, SU-500 and SU-600 by Toray Industries, Inc., NF-45, NF-70 and NF-90 by Dow Chemical Corp., SelRO™MPS/T-20, SelRO™PS/T-21, SelRO™MPS/T-31, SelRO™MPS/T-34, SelRO™MpS/T-36, SelRO™MPS-44, SelRO™MPS-50 and SelRO™MPS-60 by Koch Industries, Inc.

Preferred among these are NF membranes by Koch Industries, Inc. These NF membranes are composite membranes with polystyrene (PS) and polyacrylonitrile (PAN) as substrates, and they may be used in all pH ranges (pH=0-14). Strongly alkalinic resist stripping waste liquids can therefore be introduced directly into the membrane separating apparatus 7 without neutralization. For example, the NF membrane SelRO™MPS/T-36 by Koch Industries, Inc., with a molecular weight cutoff of 1000, may be used.

The membrane used for the invention need only have a molecular weight cutoff of 100-1500, and there are no other particular restrictions on the NF membrane.

The form of the membrane may be, for example, tubular, spiral or the like.

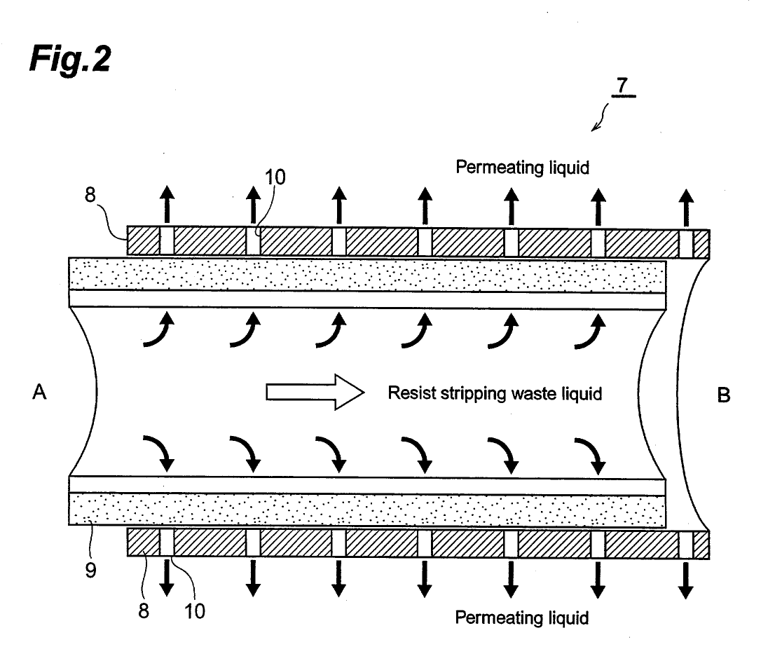

As shown in FIG. 2, the membrane separating apparatus 7 is constructed with a support pipe 8 made of stainless steel, and a tubular-shaped NF membrane 9 provided in a manner fitted inside the support pipe 8. A plurality of holes 10 are provided in the support pipe 8. The NF membrane 9 is provided in a detachable manner with respect to the support pipe 8.

For membrane separating treatment, the resist stripping waste liquid is supplied through the introduction end A in FIG. 2. As shown in FIG. 2, the permeating components in the resist stripping waste liquid pass through the fine holes in the NF membrane 9 and then through the holes 10 in the support pipe 8 to be drained through the conduit 11 as the permeating liquid.

The concentrated liquid may be disposed of, but it is preferably recirculated from the membrane separating apparatus 7 through the conduit 12 to the concentrating tank 4 as shown in FIG. 1. In this case, the concentrated liquid separated by the NF membrane 9 of the membrane separating apparatus 7 is recirculated through the conduit 12 to the concentrating tank 4 upstream from the membrane separating apparatus 7, so that the resist stripping waste liquid stored in the concentrating tank 4 can be filtered while being circulated.

This allows effective utilization of the alkanolamine and organic solvent, without having to dispose of them. It is thus possible to reduce the amount of the alkanolamine and organic solvent supplied to the concentration-adjusting tank 7 described hereunder, as compared to systems in which the concentrated liquid separated at the membrane separating apparatus 7 is discarded.

A flow meter 14 and valve are situated in the conduit 11, while a valve 15 and flow meter 16 are also situated in the conduit 12. Opening of the valve 15 and the flow-regulating pump 5 can be adjusted based on the flow rates measured by the flow meters 14, 16 to allow the ratio of the permeating liquid flow and concentrated liquid flow to be adjusted as desired.

The permeating liquid obtained at the membrane separating apparatus 7 is introduced into a concentration-adjusting tank 17 through the conduit 11. The concentration-adjusting tank 17 stores the permeating liquid obtained from the membrane separating apparatus 7 and adjusts the alkanolamine and organic solvent concentrations. A drain conduit 32 for drainage of the resist stripping waste liquid is also connected to the storage tank 34 and a valve 33 is situated in the drain conduit 32, so that efficient operation can be accomplished by deactivating the flow-regulating pump 5 based on a signal from the concentration-adjusting tank 17 and opening the valve 33 based on a signal from the storage tank 34.

The alkanolamine may also be supplied to the concentration-adjusting tank 17 from an alkanolamine storage tank 18 through a conduit 19. The alkanolamine is supplied to the concentration-adjusting tank 17 by opening of a valve 20 and activation of a pump 21.

Examples of alkanolamines that may be used include monoethanolamine, diethanolamine, triethanolamine, N,N-dimethylethanolamine, N,N-diethylethanolamine, aminoethylethanolamine, N-methyl-N,N-diethanolamine, N,N-dibutylethanolamine, N-methylethanolamine and 3-amino-1-propanol. The alkanolamine supply means consists of the alkanolamine storage tank 18, conduit 19, valve 20 and pump 21.

The organic solvent may also be supplied to the concentration-adjusting tank 17 from an organic solvent storage tank 22 through a conduit 23. The organic solvent is supplied to the concentration-adjusting tank 17 by opening of a valve 24 and activation of the pump 21.

The organic solvent referred to here is an organic solvent other than the aforementioned alkanolamine, and examples of such organic solvents which may be used include dimethylsulfoxide-based stock solutions, N-methylpyrrolidone-based stock solutions and glycolether-based stock solutions. The organic solvent supply means consists of the pump 21, organic solvent storage tank 22, conduit 23 and valve 24.

A resist stripping regenerated liquid is thus obtained by concentration adjustment at the concentration-adjusting tank 17. The resist stripping regenerated liquid is introduced into the resist stripping apparatus 1 through a conduit 27, by opening of a valve 25 and activation of a pump 26.

A portion of the resist stripping regenerated liquid is returned to the conduit 27 through a by-pass conduit 28. The by-pass conduit 28 comprises a first spectrophotometer 29 which measures the alkanolamine concentration in the resist stripping regenerated liquid and a second spectrophotometer 30 which measures the organic solvent concentration in the resist stripping regenerated liquid.

The first spectrophotometer 29 and the second spectrophotometer 30 are preferably connected to a control device 31 which controls the valves 20, 24. This will allow the valves 20, 24 to be controlled based on the alkanolamine and organic solvent concentrations measured by the first spectrophotometer 29 and the second spectrophotometer 30. The alkanolamine and organic solvent concentrations are thus maintained at constant values in the resist stripping regenerated liquid in the concentration-adjusting tank 17.

The resist stripping regenerated liquid is usually not introduced in a continuous manner into the resist stripping apparatus 1, and hence there will be some periods without introduction into the resist stripping apparatus 1. The valve 25 is closed during such periods, while the resist stripping regenerated liquid will also not flow through the conduit 27 and the bypass conduit 28 and will therefore not be available for absorbance measurement by the first spectrophotometer 29 and the second spectrophotometer 30.

The resist stripping waste liquid regenerating apparatus according to this embodiment is provided with a branching conduit 37 which connects the concentration-adjusting tank 17 with a section of the conduit 27 between the pump 26 and the valve 25. Thus, when the valve 25 is closed, the resist stripping regenerated liquid flowing through the conduit 27 is sent to the concentration-adjusting tank 17 through the branching conduit 37. The liquid in the concentration-adjusting tank 17 continues to flow through the conduit 27 and by-pass conduit 28 by the action of the pump 26.

Even when the resist stripping regenerated liquid is not being introduced into the resist stripping apparatus 1, absorbance can still be measured by the first spectrophotometer 29 and the second spectrophotometer 30.

An example of a regenerating method for resist stripping waste liquids using the regenerating apparatus for resist stripping waste liquids described above will now be explained.

First, the resist stripping waste liquid obtained at the resist stripping apparatus 1 is received at the storage tank 34 and then transported by a pump 2 through a conduit 3 to the concentrating tank 4.

The resist stripping waste liquid stored in the concentrating tank 4 is introduced by the flow-regulating pump 5 through the conduit 6 into the membrane separating apparatus 7, and the resist stripping waste liquid is separated into a concentrated liquid and permeating liquid by the membrane of the membrane separating apparatus 7. The permeating liquid obtained at the membrane separating apparatus 7 is transported to the concentration-adjusting tank 17 through the conduit 11.

Since a membrane with a molecular weight cutoff of 100-1500 is used in the membrane separating apparatus 7, the resist dissolved in the resist stripping waste liquid cannot pass through the membrane and remains in the concentrated liquid, while the resist can hardly pass with the permeating liquid. In other words, the membrane removes the resist from the resist stripping waste liquid to produce the permeating liquid (membrane separating step).

Meanwhile, the concentrated liquid obtained from the membrane separating apparatus 7 is recirculated to the concentrating tank 4 through the valve 15 and conduit 12. It is therefore possible to filter the resist stripping waste liquid stored in the concentrating tank 4 while circulating it. The alkanolamine and organic solvent can thus be effectively utilized without being discarded. This can significantly reduce the amount of alkanolamine and organic solvent which must be supplied to the concentration-adjusting apparatus 17, as compared to systems in which the concentrated liquid separated by the membrane separating apparatus 7 is discarded after use. This filtration of the resist stripping waste liquid while circulating it increases the resist concentration in the concentrating tank 4.

When the resist concentration in the concentrating tank 4 increases, the filtration efficiency of the resist stripping waste liquid in the membrane separating apparatus 7 decreases. It is therefore preferred to monitor the resist concentration in the permeating liquid and drain the resist in the concentrating tank 4 as appropriate. This can reduce the amount of alkanolamine and/or organic solvent to be supplied to the concentration-adjusting tank 17.

The ratio of the permeating liquid flow D to the concentrated liquid flow C (D/C) is preferably 0.1-0.2. Appropriate monitoring to maintain this optimum flow ratio for the concentrated liquid and permeating liquid can increase the permeating liquid yield while maintaining satisfactory permeating liquid quality, reduce disposal of the alkanolamine and organic solvent for maximum efficiency, and adequately reduce the amounts of alkanolamine and organic solvent that must be supplied to the concentration-adjusting tank 17.

If the ratio is less than 0.1, the permeating liquid yield will tend to be lower resulting in poor economy, while if it is greater than 0.2, the membrane will tend to foul and the permeating liquid quality will tend to be inferior. The flow ratio of the permeating liquid with respect to the concentrated liquid may be adjusted by opening or closing the valve 15 and varying the flow-regulating pump 5, based on the flow rates measured by the flow meters 14, 16.

The alkanolamine and organic solvent concentrations in the concentration-adjusting tank 17 are adjusted against the permeating liquid being transported to the concentration-adjusting tank 17. The alkanolamine is supplied to the concentration-adjusting tank 17 through the conduit 19 from the alkanolamine storage tank 18, by opening of the valve 20 and activation of the pump 21. Opening of the valve 24 allows the organic solvent to be supplied to the concentration-adjusting tank 17 through the conduit 23 from the organic solvent storage tank 22. If necessary, a valve 35 may be opened to drain the waste liquid from the concentration-adjusting tank 17 through a drain conduit 36. The alkanolamine and organic solvent concentrations are thereby adjusted in the permeating liquid in the concentration-adjusting tank 17, to obtain the resist stripping regenerated liquid (concentration-adjusting step).

It is thereby possible to achieve adequate reduction in the resist concentration of the permeating liquid. This reduces the need for diluting the resist concentration in the concentrating-adjusting tank 17, to allow substantial reduction in the amount of alkanolamine and organic solvent which must be supplied to the concentration-adjusting tank 17. As a result, the total amount of alkanolamine and organic solvent used in the regenerating apparatus of the invention is smaller, while the amount of waste liquid drained from the storage tank 34 through the conduit 32 is also significantly reduced.

The waste liquid is usually burned away, releasing CO₂ gas into the atmosphere, but since this embodiment of the invention greatly reduces the amount of waste liquid drained from the storage tank 34, the volume of CO₂ released into the atmosphere is also substantially reduced. The regenerating apparatus therefore helps contribute to preventing global warming by CO₂.

Furthermore, since the amounts of the alkanolamine and organic solvent supplied to the concentration-adjusting tank 17 can be reduced, the running cost may be significantly lowered. Also, because substantially no resist is present in the permeating liquid, the resist stripping waste liquid can be regenerated to almost the same state as the original resist stripping liquid.

The resist stripping regenerated liquid obtained in this manner is introduced into the resist stripping apparatus 1 from the concentration-adjusting tank 17 through the conduit 27, by activation of the valve 25 and pump 26.

A portion of the resist stripping regenerated liquid is introduced into the by-pass conduit 28 and returned to the conduit 27 via the first spectrophotometer 29 and second spectrophotometer 30. The first spectrophotometer 29 measures the alkanolamine concentration, while the second spectrophotometer 30 measures the organic solvent concentration. Opening of the valves 20, 24 is regulated by a control device 31 based on the measured alkanolamine and organic solvent concentrations. The alkanolamine and organic solvent concentrations are thus maintained at constant values in the resist stripping regenerated liquid.

As explained above, the regenerating apparatus and method for resist stripping waste liquids according to the invention can adequately reduce the resist concentration of a permeating liquid. This minimizes the need for diluting the resist concentration, to allow substantial reduction in the amount of alkanolamine and organic solvent which must be supplied to the concentration-adjusting tank. As a result, since the amount of waste liquid drained from the storage tank is greatly reduced, the volume of CO₂ released into the atmosphere is also substantially lower, thereby contributing to the prevention of global warming by CO₂.

Furthermore, since the amounts of the alkanolamine and organic solvent supplied to the concentration-adjusting tank can be adequately reduced, the running cost may be significantly lowered. Also, because substantially no resist is present in the permeating liquid, the resist stripping waste liquid can be regenerated to almost the same state as the original resist stripping liquid.

What is claimed is:

1. A resist stripping waste liquid regenerating apparatus which regenerates a resist stripping waste liquid containing an alkanolamine, an organic solvent and a resist, the resist stripping waste liquid regenerating apparatus being provided with
a membrane separating apparatus having a membrane with a molecular weight cutoff of 100-1500 for separation of said resist stripping waste liquid into a concentrated liquid and a permeating liquid,
a concentration-adjusting tank which stores said permeating liquid and adjusts the concentration of the alkanolamine and organic solvent in said permeating liquid,
alkanolamine supply means which supplies the alkanolamine to said concentration-adjusting tank, and
organic solvent supply means which supplies the organic solvent to said concentration-adjusting tank.

2. A resist stripping waste liquid regenerating apparatus according to claim 1, wherein said membrane is a nanofiltration membrane.

3. A resist stripping waste liquid regenerating apparatus according to claim 1, which is further provided with recirculating means to recirculate the concentrated liquid separated by said membrane to the upstream end of said membrane separating apparatus.

4. A resist stripping waste liquid regenerating method for regenerating resist stripping waste liquids containing an alkanolamine, an organic solvent and a resist, the resist stripping waste liquid regenerating method comprising
a membrane separating step in which a membrane with a molecular weight cutoff of 100-1500 is used to separate said resist stripping waste liquid into a concentrated liquid and a permeating liquid, and
a concentration-adjusting step in which the alkanolamine and/or the organic solvent are supplied to said permeating liquid to adjust the concentration of said permeating liquid.
